(19) United States
(12) Patent Application Publication
(10) Pub. No.: US 2015/0009414 A1
(43) Pub. Date: Jan. 8, 2015

(54) IMAGE OUTPUT APPARATUS, IMAGE OUTPUT SYSTEM, AND IMAGE OUTPUT CONTROL PROGRAM

(71) Applicants: Aritaka HAGIWARA, Kanagawa (JP); Ryo IWASAKI, Tokyo (JP); Yoko SUGIURA, Kanagawa (JP)

(72) Inventors: Aritaka HAGIWARA, Kanagawa (JP); Ryo IWASAKI, Tokyo (JP); Yoko SUGIURA, Kanagawa (JP)

(21) Appl. No.: 14/322,018

(22) Filed: Jul. 2, 2014

(30) Foreign Application Priority Data
Jul. 8, 2013 (JP) 2013-142985

(51) Int. Cl. H04N 5/74

(52) U.S. Cl. CPC H04N 5/74
USPC 348/744

(57) ABSTRACT

Provided are an image output apparatus, an image output system, and an image output control program. Each of the image output apparatus, the image output system, and the image output control program outputs an image based on a video signal generated from data, detects a storage medium having available data stored therein, obtains the data stored in the newly detected storage medium in response to the detection, switches, from an input path of the image to be output to an input path associated with the newly detected storage medium, and outputs a video signal generated from the obtained data after the switching of the input path is complete.

### CROSS-REFERENCE TO RELATED APPLICATION

This patent application is based on and claims priority pursuant to 35 U.S.C. §119(a) to Japanese Patent Application No. 2013-142985, filed on Jul. 8, 2013, in the Japan Patent Office, the entire disclosure of which is hereby incorporated by reference herein.

### BACKGROUND

1. Technical Field

Example embodiments relate to an image output apparatus, an image output system, and an image output control program.

2. Background Art

Projectors are known as a display device that can be viewed by a number of people. Projectors project moving images on a large screen by projecting the images based on the input video signals. In addition to the function of projecting moving images, projectors that are provided with information processing capability have been proposed. Such projectors can generate video signals based on files in specified formats (hereinafter, files in specified formats are referred to as contents), and project still and moving images on a screen.

Contents are stored in several kinds of external devices such as an external medium connected through a universal serial bus (USB) and a content server accessible through the network. In the projectors provided with the information processing capability, when one of such external devices is selected, the contents are obtained from the selected external device, and the projection of the obtained contents is initiated. In so doing, the input source of image data, which provides a projection unit with the image data to be projected on a screen, needs to be switched to a module that obtains contents from the selected external device or to a module that generates video data from the contents stored in the selected external device.

### SUMMARY

Embodiments of the present invention described herein provide an image output apparatus, an image output system, and an image output control program. Each of the image output apparatus, the image output system, and the image output control program outputs an image based on a video signal generated from data, detects a storage medium having available data stored therein, obtains the data stored in the newly detected storage medium in response to the detection, switches, from an input path of the image to be output to an input path associated with the newly detected storage medium, and outputs a video signal generated from the obtained data after the switching of the input path is complete.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 illustrates the configuration of a projector according to an example embodiment of the present invention.

FIG. 2 is a block diagram of a schematic hardware configuration of a projector according to an example embodiment of the present invention.

FIG. 3 is a block diagram of the functional configuration of a projector according to an example embodiment of the present invention.

FIG. 4 is a block diagram of the functional configuration of a main controller according to an example embodiment of the present invention.

FIG. 5 is a sequence diagram of the processes performed by elements of a main controller, according to an example embodiment of the present invention.

FIG. 6 is a flowchart of the processes of determining whether any projectable content is present, according to an example embodiment of the present invention.

FIG. 7 illustrates the connection information of an external device according to an example embodiment of the present invention.

FIG. 8 illustrates a configuration screen of a projector according to an example embodiment of the present invention.

FIG. 9 illustrates a screen on which thumbnails are displayed, according to an example embodiment of the present invention.

FIG. 10 is a sequence diagram of the processes performed by elements of a main controller, according to an example embodiment of the present invention.

FIG. 11 illustrates the configuration of a system according to an example embodiment of the present invention.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits (ASICs), field programmable gate arrays (FPGAs) computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Example embodiments of the present invention will be described below in detail with reference to the drawings. In the present example embodiment, a projector is described that projects on a screen an image from the contents stored in an external device. The external device is connected to the projector, and stores files in specific formats such as still-image files, moving-image files, and document files (i.e., contents). The connection of an external device to the projector indicates that the data of contents has become available, and such availability may be achieved by receiving the data of contents through the network or by storing the data of contents in a specific folder of the external device.

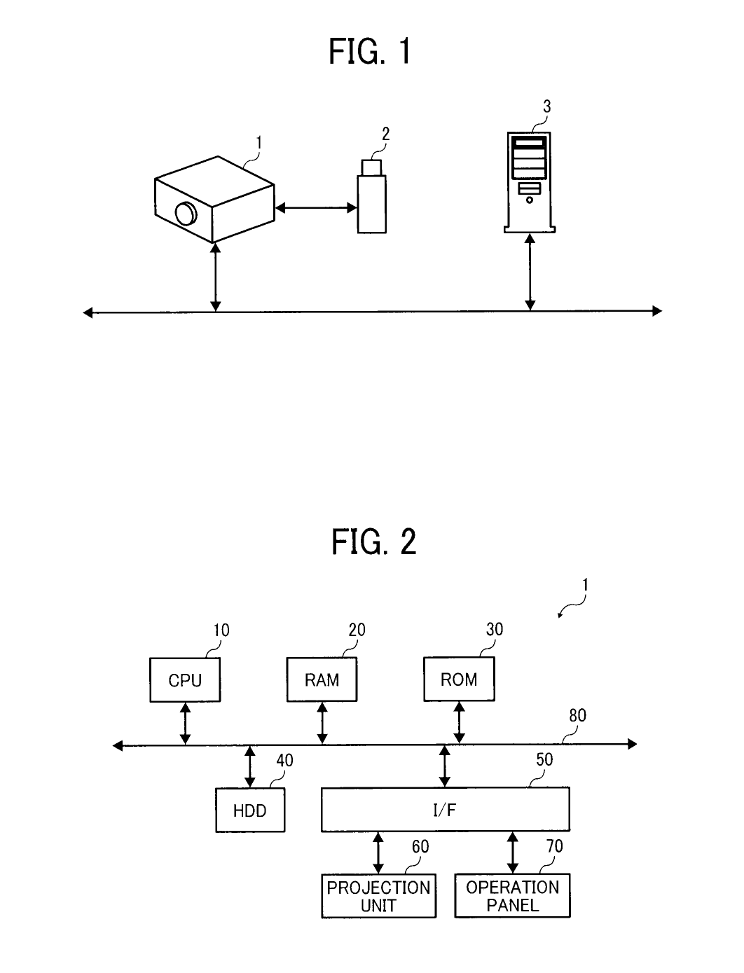

FIG. 1 illustrates the configuration of a projector 1 according to an example embodiment of the present invention. As illustrated in FIG. 1, the projector 1 according to the present example embodiment is directly connected to an external memory 2, and is connected to a content server 3 through the network.

The projector 1 is an image output apparatus that projects images on a screen or the like, and is provided with the function of projecting images based on the input video signals, or information processing capability and network communication capability by which video signals are generated based on contents and projection is performed. Accordingly, the projector 1 is capable of obtaining contents from the external memory 2 and the content server 3, generating video signals from the obtained contents, and performing projection based on the generated video signals.

The external memory 2 is a portable storage medium that is connected to the projector 1 through a USB interface or the like. The content server 3 provides a storage area through the network. Note that the external memory 2 and the content server 3 may collectively be referred to as external devices in the following description.

Next, the hardware configuration of the projector 1 according to the present example embodiment is described. FIG. 2 is a block diagram illustrating the hardware configuration of the projector 1 according to the present example embodiment. As illustrated in FIG. 2, the projector 1 according to the present example embodiment includes a configuration similar to that of ordinary information processing devices such as personal computers (PCs) and servers. More specifically, a central processing unit (CPU) 10, a random access memory (RAM) 20, a read only memory (ROM) 30, a hard disk drive (HDD) 40, and an interface (I/F) 50 are connected to each other via a bus 80 in the projector 1 according to the example embodiment of the present invention. Moreover, the I/F 50 is connected to a projection unit 60 and an operation panel 70.

The CPU 10 serves as a computation unit, and controls the entire operation of the projector 1. The RAM 20 is a volatile storage medium capable of reading and writing data at high speed, and is used as a working area while the CPU 10 is processing data. The ROM 30 is a read-only nonvolatile storage medium in which firmware programs or the like are stored. The volatile HDD 40 is a data readable/writable nonvolatile storage medium in which an OS (operating system), various kinds of control programs, applications, programs, or the like are stored.

The I/F 50 connects various kinds of hardware, networks, or the like to the bus 80, and controls these elements. The projection unit 60 projects the images generated by the projector 1 on a screen. The operation part 70 is a user interface used to operate the projector 1, and is realized by operation buttons arranged on the projector 1 and a remote control or the like used to operate the projector 1.

In such a hardware configuration, programs stored on the ROM 30, the HDD 40, or in another storage medium such as an optical disk are read by the RAM 20, and the programs are run under the control of the CPU 10. This series of processes configures a software controller. The software controller as configured above is combined with hardware to configure a functional block that realizes the functions of the projector 1 according to the present example embodiment of the present invention.

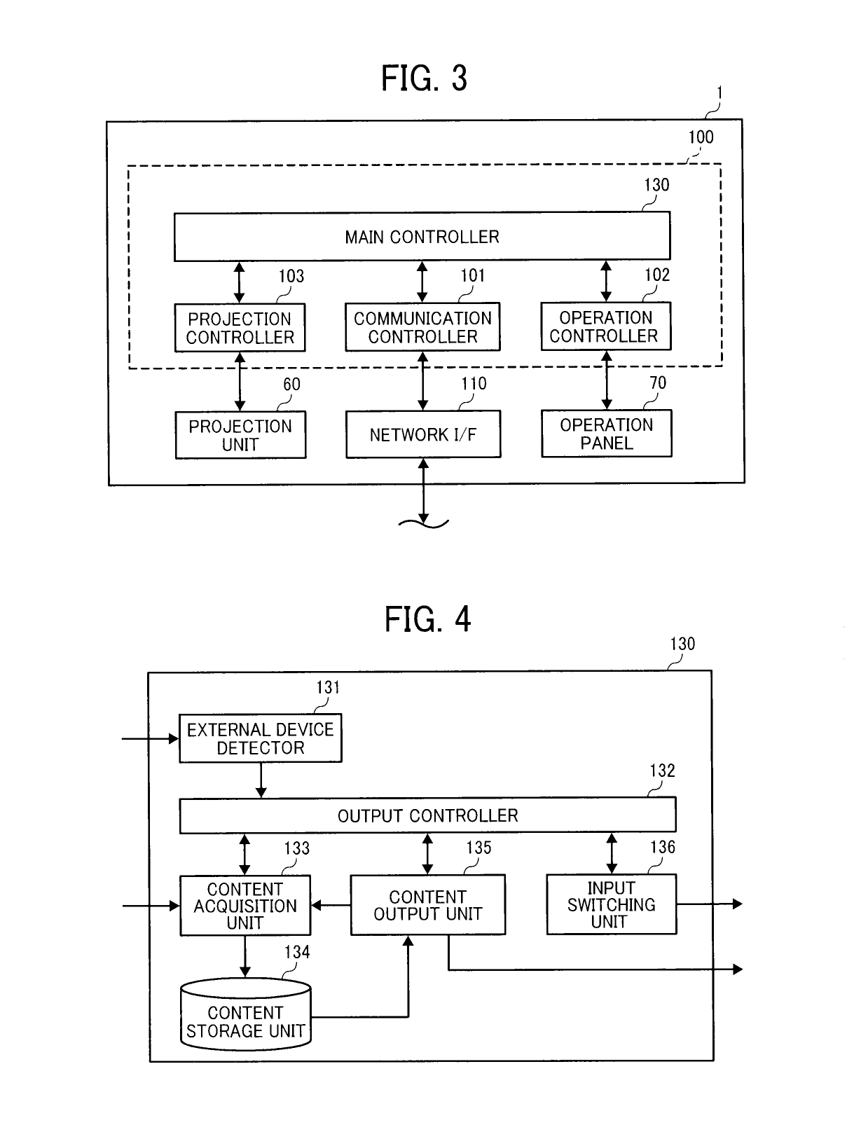

Next, the functional configuration of the projector 1 according to the present example embodiment is described with reference to FIG. 3. FIG. 3 is a block diagram illustrating the functional configuration of the projector 1 according to the present example embodiment.

As illustrated in FIG. 3, the projector 1 according to the present example embodiment includes a controller 100 and a network interface (I/F) 110, in addition to the projection unit 60 and the operation panel 70 described above with reference to FIG. 2. The controller 100 includes a communication controller 101, an operation controller 102, a projection controller 103, and a main controller 130.

Note that in addition to the elements illustrated in FIG. 3, the projector 1 further includes a connection terminal to be connected to an external memory 2, and the main controller 130 is capable of detecting a connection signal generated when the external memory 2 is connected to the connection terminal. Moreover, the main controller 130 is capable of reading data from the external memory 2 that is connected to the connection terminal. The network I/F 110 is an interface used to enable the projector 1 to communicate with other devices through the network, and an Ethernet (registered trademark) interface or the like is used as the network I/F 110. The connection terminal for the network I/F 110 and the external memory 2 is realized by the I/F 50 that is illustrated in FIG. 2.

The controller 100 is configured by a combination of software and hardware. More specifically, a control program stored in the ROM 30 or other kinds of nonvolatile memory or in a nonvolatile storage medium such as the HDD 40 and an optical disk is loaded into a volatile memory (this will be referred to simply as a memory) such as the RAM 20, and the controller 100 is configured by the combination of a software controller that operates under the control of the CPU 10 and hardware such as an integrated circuit. The controller 100 serves as a controller that controls the entirety of the projector 1.

The communication controller 101 obtains the data input through the network I/F 110, and also transmits data to other devices through the network I/F 110. In the present example embodiment, the main controller 130 controls the communication controller 101 to obtain contents from the content server 3 through the network I/F 110.

The operation controller 102 receives an operation signal from the operation part 70, and transmits the received operation signal to the main controller 130. The projection controller 103 obtains the video signal generated by the main controller 130, and makes the projection unit 60 project the image based on the obtained video signal.

The main controller 130 controls the modules of the controller 100 to control the operation of the projector 1. The main controller 130 is realized by software that is capable of performing desired functions. The main controller 130 also has the function of obtaining contents such as image files and document files from the connected external device as image data to be projected on the projection unit 60, and the function of generating a video signal used to control the projection controller 103.

The projector 1 starts projecting images on a screen from the beginning of the contents stored when the input is switched due to a connected external device, and prevents a delay in starting the projection. The projector 1 according to the present example embodiment obtains contents from an external device at the timing when the connection of the external device is detected (i.e., at the timing when the data stored in the external device becomes available), and switches the input in response to the detection of the external device. When the input has been switched, video signals are generated from the obtained contents, and images are projected based on the generated video signals. The functional configuration of the main controller 130 according to the present example embodiment is described below.

FIG. 4 is a block diagram illustrating the functional configuration of the main controller 130 according to an example embodiment of the present invention. As illustrated in FIG. 4, the main controller 130 includes an external device detector 131, an output controller 132, a content acquisition unit 133, a content storage unit 134, a content output unit 135, and an input switching unit 136.

The external device detector 131 detects the connection of an external device. In other words, the external device detector 131 serves as a storage medium detector that detects the connection of a storage medium in which data such as contents are stored, i.e., an external device. Such detection indicates that data can be obtained from a storage medium. More specifically, the external device detector 131 is configured for each one of the external devices that are available. For example, an external device detector 131a detects the connection of the external memory 2, and an external device detector 131b detects the connection of the content server 3.

The external device detector 131a detects the connection of the external memory 2, by receiving a connection signal generated when a connecting operation of the external memory 2 is performed through the connection terminal of the external memory 2 (for example, when a USB memory is connected to the USB terminal of the projector 1). The external device detector 131b detects the connection of the content server 3, by receiving a connection signal generated when the content server 3 is connected through the network I/F 110 (for example, when connecting operation such as the modification of connection settings is performed to be connected to the content server 3).

Once the external device detector 131 detects the connection of an external device, the external device detector 131 notifies the output controller 132 of the established connection to that external device. The external device detector 131 may periodically check the connection state of an external device to the projector 1, instead of receiving a connection signal from the connection terminal of the external memory 2 or through the network I/F.

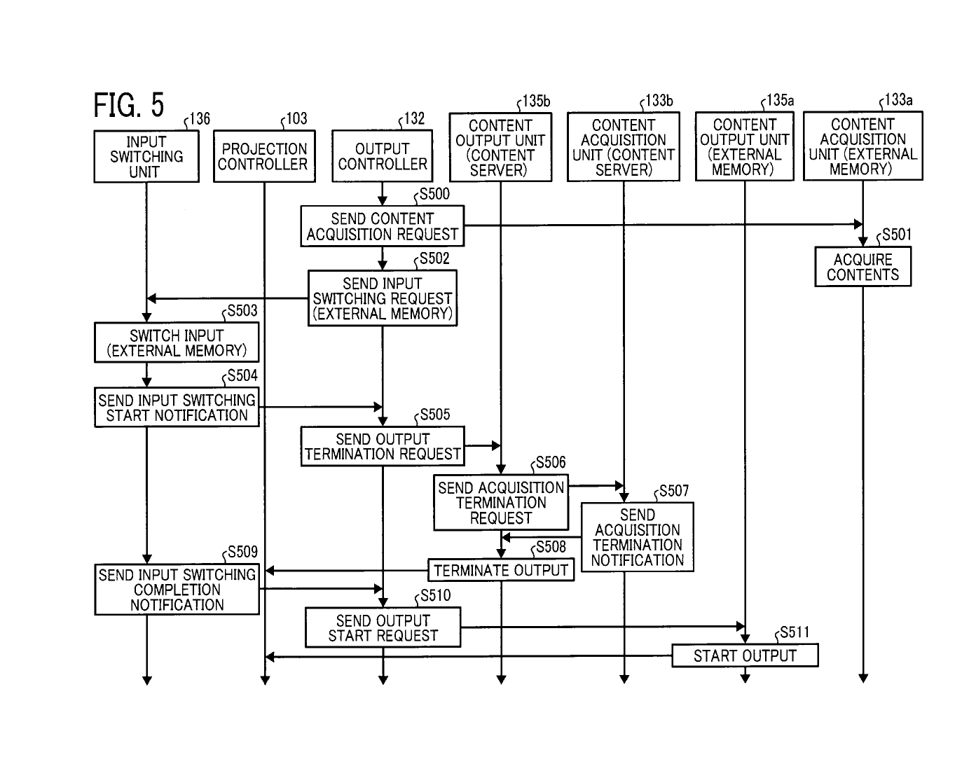

Upon receiving notification from the external device detector 131, the output controller 132 requests the content acquisition unit 133 that corresponds to the connected external device to obtain contents from the external device, and requests the content output unit 135 and the input switching unit 136 to perform processes as desired. The processes in detail are described later with reference to FIG. 5.

In response to the instructions generated by the output controller 132, the content acquisition unit 133 obtains the contents from the external device, and stores the obtained contents in the content storage unit 134. In other words, the content acquisition unit 133 serves as a data obtaining unit that obtains data such as contents stored in an external device. More specifically, the content acquisition unit 133 is configured for each external device, and for example, a content acquisition unit 133a obtains the contents from the external memory 2, and a content acquisition unit 133b obtains the contents from the content server 3. Upon receiving an acquisition termination request from the content output unit 135, the content acquisition unit 133 terminates the content acquisition process. The processes in detail are described later with reference to FIG. 5.

The content acquisition unit 133 may obtain the firstly-accessed contents (for example, a video file) from an external device as contents to be output, or may obtain the files from an external device in the order sorted by a specific rule (for example, in an alphabetical order) as contents to be output. Alternatively, the files that are stored in a specific folder of an external device may be obtained as contents to be output.

The content storage unit 134 stores the contents obtained by the content acquisition unit 133 so as to be available for the content output unit 135. In response to the instructions generated by the output controller 132, the content output unit 135 obtains the contents of the specified external device from the content storage unit 134 and generates a video signal, and outputs the generated video signal to the projection controller 103. In other words, the content output unit 135 serves as a video signal output unit that outputs a video signal generated from the obtained contents.

More specifically, the content output unit 135 is configured for each external device, and for example, a content output unit 135a generates a video signal from the contents stored in the external memory 2, and a content output unit 135b generates a video signal from the contents stored in the content server 3. In response to the instructions generated by the output controller 132, the content output unit 135 sends a content-acquisition termination request to the content acquisition unit 133 of the corresponding external device. The processes in detail are described later with reference to FIG. 5.

The input switching unit 136 controls the projection controller 103 in accordance with the instructions generated by the output controller 132, to switch the input path to the projection unit 60 to an input path used for generating a video signal from the contents stored in the connected external device. In other words, the input switching unit 136 performs switching such that the video signal output from the content output unit 135 that corresponds to the connected external device is input to the projection unit 60. Note that “to switch the input path to an input path used for generating a video signal from the contents stored in the connected external device” is hereinafter described as “to switch the input to an input that corresponds to the newly-connected external device”.

Next, the processes performed by elements of the main controller 130 according to the present example embodiment are described with reference to FIG. 5. FIG. 5 is a sequence diagram illustrating the processes performed by the elements of the main controller 130, according to an example embodiment of the present invention. In the following description with reference to FIG. 5, it is assumed that the external memory 2 is newly connected to the projector 1 when the moving images based on the contents stored in the content server 3 are being output to the projector 1, and the external device detector 131a detects that the external memory 2 is connected to the projector 1.

As illustrated in FIG. 5, when the output controller 132 receives a notification from the external device detector 131a that the connection of the external memory 2 is detected, the output controller 132 sends a content acquisition request for the contents stored in the connected external memory 2 to the content acquisition unit 133a that is associated with the external memory 2 (S500). In response to the content acquisition request sent from the output controller 132, the content acquisition unit 133a obtains the contents from the connected external memory 2, and stores the obtained contents in the content storage unit 134 (S501).

After sending the content acquisition request to the content acquisition unit 133a, the output controller 132 sends an input switching request to the input switching unit 136 for accepting the external memory 2 (S502). Upon receiving the input switching request from the output controller 132, the input switching unit 136 controls the projection controller 103 to start switching from the input to the projection unit 60 to the input to the external memory 2 (S503).

After the input switching process starts, the input switching unit 136 sends an input switching start notification to the output controller 132 (S504). Upon receiving the input switching start notification, the output controller 132 sends a video-signal output termination request to the content output unit 135b that is associated with the content server 3 that is outputting the contents corresponding to the moving images that are currently projected onto the screen (S505).

Upon receiving the video-signal output termination request from the output controller 132, the content output unit 135b sends a content-acquisition termination request to the content acquisition unit 133b that is associated with the content server 3 (S506). Upon receiving the content-acquisition termination request from the content output unit 135b, the content acquisition unit 133b terminates the content acquisition from the content server 3 and sends a content-acquisition termination notification to the content output unit 135b that is associated with the content server 3 (S507). Note that a content-acquisition termination request and content-acquisition termination process may be omitted, for example, when a still image is obtained from an external device and no further communication is required for projecting the image.

Upon receiving the content-acquisition termination notification, the content output unit 135b controls the projection controller 103 to terminate the projection from the contents stored in the content server 3 (S508).

On the other hand, after the input switching process for the external memory 2 starts, the input switching unit 136 sends an input switching completion notification to the output controller 132 (S509). Upon receiving the input switching completion notification, the output controller 132 sends a video-signal output start request to the content output unit 135a that is associated with the external memory 2 (S510).

In response to the video-signal output start request sent from the output controller 132, the content output unit 135a obtains the contents from the content storage unit 134, and starts outputting the video signal to the projection controller 103 (S511). Accordingly, after the switching process to the input for the external memory 2 is complete, the projection of the contents stored in the external memory 2, from which the contents have been obtained, starts.

As described above, in the present example embodiment, the contents are obtained from a newly-connected external device at the time when the external device is newly connected, and the input to the projection unit 60 is switched to an input that corresponds to the newly-connected external device. When the switching process is complete, the projection of the images starts based on the video signals generated from the contents obtained when the external device was newly connected. As the preparation for image output is made by starting acquisition of contents at the timing when an external device is newly connected, the image output can be started immediately, based on the contents whose acquisition process is complete at the time when input switching is done. Accordingly, after input switching due to a newly-connected external device is performed, the projector 1 can start projecting images on a screen from the beginning of the contents stored in the newly-connected external device, and prevent a delay in starting the projection.

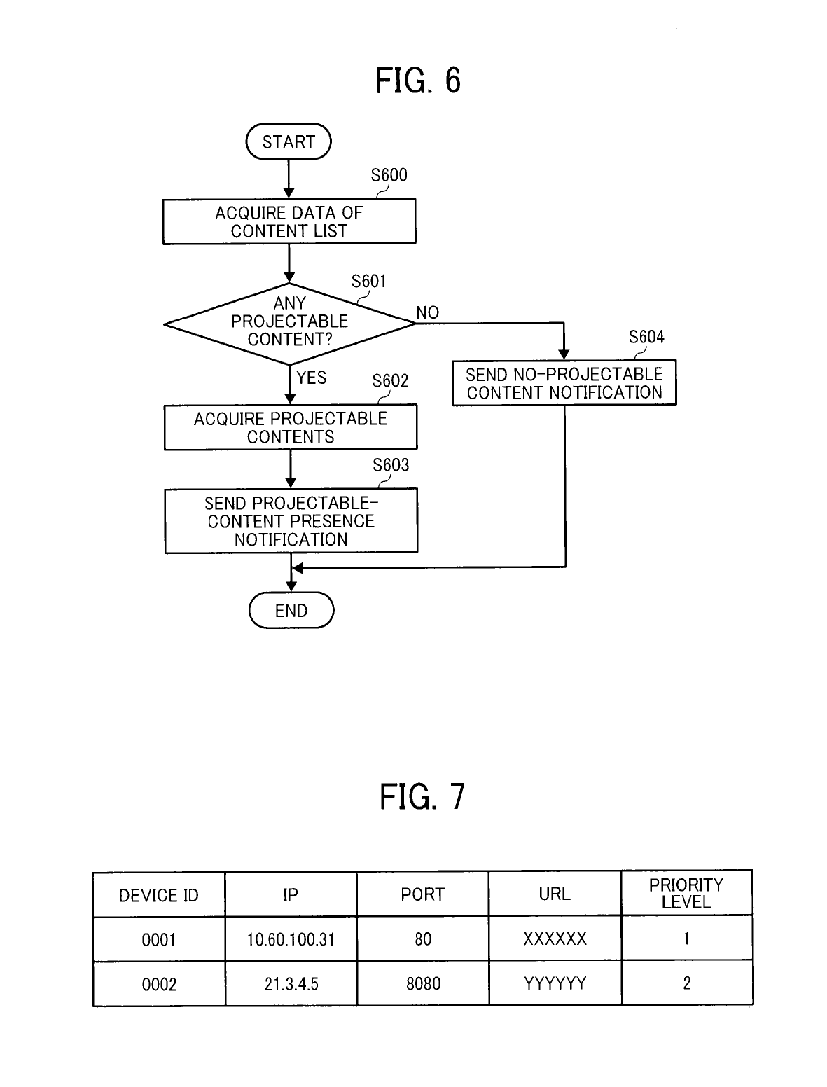

Next, an embodiment is described in which when an external device is newly connected to the projector 1, whether or not each of the contents stored in the connected external device is projectable on the screen by the projector 1 that is connected to the external device is determined before obtaining the contents from the connected external device. FIG. 6 is a flowchart of the processes of determining whether any projectable content is present, which are performed by the content acquisition unit 133 according to the present example embodiment of the present invention. In FIG. 6, the processes performed by the content acquisition unit 133a, which has received the content acquisition request sent from the output controller 132, are described as an example.

As illustrated in FIG. 6, prior to the acquisition of the contents stored in the connected external memory 2, the content acquisition unit 133a obtains a list of the contents stored in the external memory 2 (S600). The list of the contents indicates the data used to determine whether or not each of the contents stored in the external memory 2 can be projected by the projector 1 onto the screen, and includes, for example, the file extension of the contents, the header information of the files, and the file names.

The content acquisition unit 133a obtains the list of the contents, and determines whether or not each of the contents stored in the external memory 2 can be projected by the projector 1 onto the screen, based on the obtained list of the contents and projectable data formats (S601). More specifically, the projectable content includes, for example, still-image files, moving-image files, and text files. When the content acquisition unit 133a determines whether or not each content is projectable based on the file extension of the content, the content acquisition unit 133a determines that the content is projectable when the file extension of the content is, for example, one of the extension of still images (e.g., “.jpg”), the extension of moving images (e.g., “.mp4”), and the extension of text files (e.g., “.txt”).

When the contents stored in the external memory include some projectable contents (“YES” in S601), the content acquisition unit 133a obtains these projectable contents from the external memory 2 (S602). Then, the content acquisition unit 133a notifies the output controller 132 of the presence of projectable contents (S603). In this case, the output controller 132 performs the processes in S502 and the following steps.

On the other hand, when the contents stored in the external memory include no projectable content (“NO” in S601), the content acquisition unit 133a notifies the output controller 132 of the absence of a projectable content without obtaining any content from the external memory 2 (S604). In this case, the output controller 132 keeps the projection of the contents stored in the content server 3 without switching the input to the external memory 2.

According to the configuration described above, unnecessary input switching can be omitted when no projectable content is stored in the connected external device. Accordingly, the customer convenience improves. In the example embodiment described above, cases in which the content acquisition unit 133 determines whether any projectable content is present have been described. Alternatively, the output controller 132 may obtain a list of contents from the content acquisition unit 133, and may perform the processes described above based on the obtained list of contents. In this case, the output controller 132 sends a content acquisition request to the content acquisition unit 133 when it is determined that projectable contents are stored in the external device.

In the example embodiment described above, the contents are obtained from an external device when the external device is newly connected. Hereinafter, an embodiment is described in which the connection information of two newly-connected external devices is obtained when the second external device is connected within a specified period of time after the first external is connected, and the external device from which the contents are to be obtained is selected.

When an external device is newly connected, the external device detector 131 that is associated with the connected external device obtains connection information of the connected external device, and transmits the obtained connection information to the output controller 132. After the connection information of the external device is received from the external device detector 131, the output controller 132 does not send a content acquisition request for a certain period of time to the content acquisition unit 133 that is associated with the external device, but keeps the connection information.

FIG. 7 illustrates the connection information of an external device, which is kept by the output controller 132, according to an example embodiment of the present invention. As illustrated in FIG. 7, the connection information of an external device includes, for example, a device ID for uniquely identifying an external device, an Internet protocol (IP) address at which the external device is placed, a connection port number of the external device, a connection uniform resource locator (URL) of the external device, and the priority level of content acquisition. The priority level of content acquisition is set highest when, for example, the IP address at which the external device is placed and the IP address at which the projector 1 is placed are within the same segment. In other cases, each segment is set to a certain priority level of content acquisition in advance. Alternatively, the priority level of content acquisition may be set depending on the sorted order of the names of external devices or URLs.

When an external device is newly connected and then the connection of another external device is detected by the external device detector 131 within a certain period of time, the output controller 132 also keeps the connection information of the other external device. After a certain period of time has passed, the output controller 132 selects the external device with the highest priority level according to the kept connection information of external devices, and sends a content acquisition request to the content acquisition unit 133 that is associated with the selected external device. In other words, the output controller 132 serves as a storage medium selection unit that selects a storage medium from a plurality of storage media, which are the external devices whose connections have been detected, based on the priority levels.

Due to the configuration described above, the projection of the contents stored in an external device with a high priority level is performed with priority when a plurality of external devices are newly connected within a certain period of time. Accordingly, chances of projecting the contents stored in a desired external device are increased without making any selection by a user.

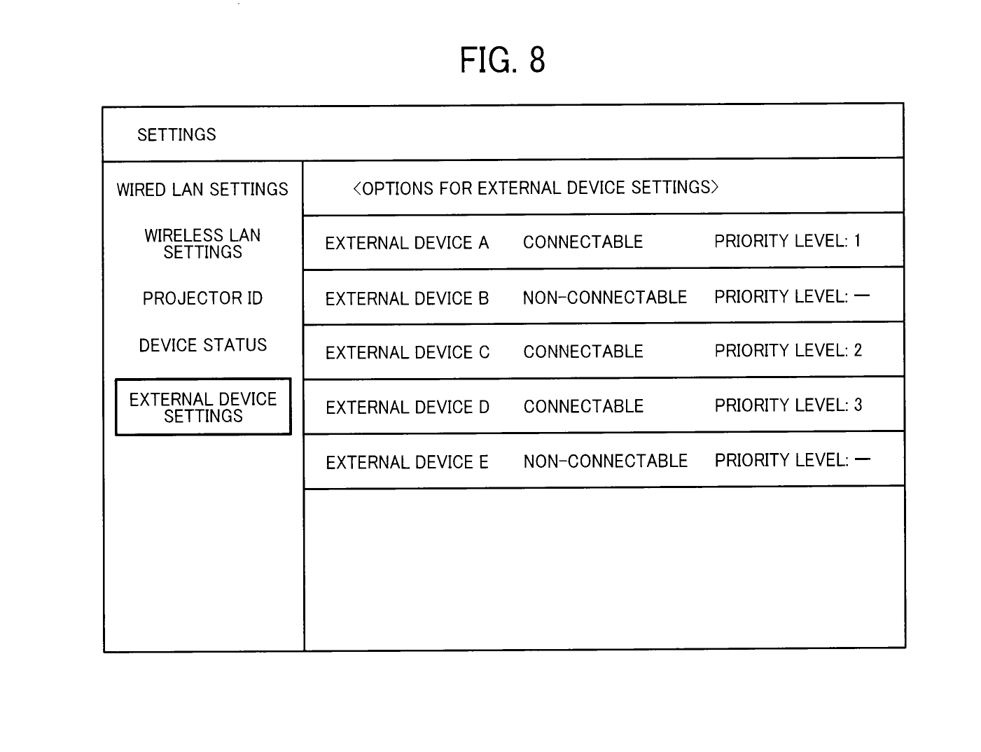

In the example embodiment described above, the priority level of content acquisition is set according to the segment of an IP address or the like. However, the priority level of content acquisition may be set through a graphical user interface (GUI) or the like that is used for configuring the projector 1. FIG. 8 illustrates a GUI used for configuring the projector 1 (hereinafter, such a GUI is referred to as “configuration screen”), according to an example embodiment of the present invention. For example, a screen generation unit of the main controller 130 generates a configuration screen as illustrated in FIG. 8, and the projection controller 103 is controlled to project the configuration screen on a screen.

As illustrated in FIG. 8, when “external device settings” is selected on the configuration screen, a list of options for connectable external devices is displayed. Some external devices are selected from the list of connectable external devices through the operation panel 70, and the connectability of the selected external devices is determined by a user. When an external device is determined to be connectable, the priority level of content acquisition from that external device is also set. Alternatively, only the list of connectable external devices may be displayed without requiring a user to determine whether each of the connectable external devices is to be connected.

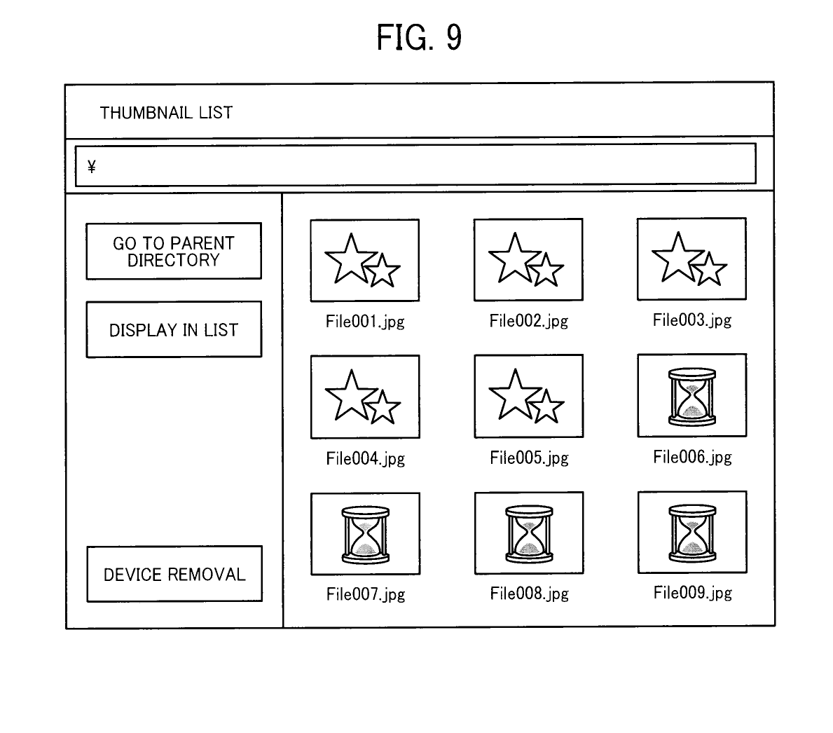

Next, an embodiment in which thumbnail images of the contents stored in an external device (i.e., reference images to check the contents) are generated is described. FIG. 9 illustrates a screen on which thumbnails of the contents stored in an external device are displayed, according to an example embodiment of the present invention. For example, a screen generation unit of the main controller 130 generates a thumbnail display screen as illustrated in FIG. 9 when the operation panel 70 is manipulated to display a thumbnail screen, and the projection controller 103 is controlled to project the thumbnail display screen on a screen.

When the generation of thumbnail images are not achieved in time, an unwanted image that indicates the thumbnail image is being generated but not ready yet (for example, an icon of a sandglass as illustrated in FIG. 9) is displayed. This situation affects the customer convenience because a user cannot check the contents quickly.

In the present example embodiment, the content acquisition unit 133 generates thumbnail images from the obtained contents before the input switching processes are performed by the input switching unit 136 or while the input switching processes are being performed by the input switching unit 136. Due to this configuration, thumbnail images are generated in advance. Accordingly, no such an image appears that indicates the thumbnail image is being generated but not ready yet, and prepared thumbnail images are displayed instantly. This configuration improves the customer convenience because a user can check the contents quickly.

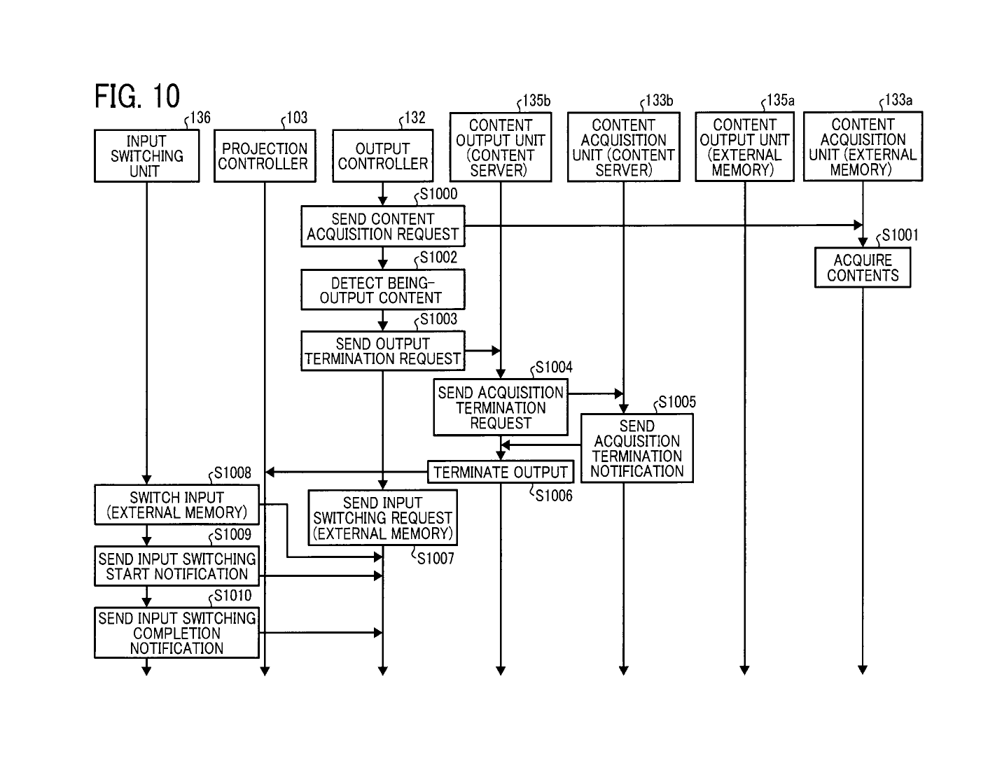

Next, an embodiment is described in which whether there is any content that is being output is checked before starting an input switching process. FIG. 10 is a sequence diagram illustrating the processes performed by elements of the main controller 130, according to an example embodiment of the present invention. In the following description with reference to FIG. 10, it is assumed that the external memory 2 is newly connected to the projector 1 when the moving images based on the contents stored in the content server 3 is being output to the projector 1, and the external device detector 131a detects that the external memory 2 is connected to the projector 1.

As illustrated in FIG. 10, when the output controller 132 receives a notification from the external device detector 131a that the connection of the external memory 2 is detected, the output controller 132 sends a content acquisition request for the contents stored in the connected external memory 2 to the content acquisition unit 133a that is associated with the external memory 2 (S1000). In response to the content acquisition request sent from the output controller 132, the content acquisition unit 133a obtains the contents from the connected external memory 2, and stores the obtained contents in the content storage unit 134 (S1001).

After the output controller 132 has sent a content acquisition request to the content acquisition unit 133a, the output controller 132 checks whether there is any content that is being output (S1002). More specifically, for example, the output controller 132 checks the control operation of the projection controller 103, and determines that there are contents that are being output when the projection controller 103 is controlling the projection to the projection unit 60. When it is determined that there are contents that are being output, the output controller 132 sends a video-signal output termination request to the content output unit 135b that is outputting the contents corresponding to the moving images that are currently projected onto the screen (S1003).

Upon receiving the video-signal output termination request from the output controller 132, the content output unit 135b sends a content-acquisition termination request to the content acquisition unit 133b that is associated with the content server 3 (S1004). Upon receiving the content-acquisition termination request from the content output unit 135b, the content acquisition unit 133b terminates the content acquisition from the content server 3 and sends a content-acquisition termination notification to the content output unit 135b that is associated with the content server 3 (S1005).

Upon receiving the content-acquisition termination notification, the content output unit 135b controls the projection controller 103 to terminate the projection from the contents stored in the content server 3 (S1006). Upon confirming that the content output unit 135b has finished outputting video signals, the output controller 132 sends an input switching request to the input switching unit 136 so as to switch the input to an input that corresponds to the external memory 2 (S1007).

Upon receiving the input switching request from the output controller 132, the input switching unit 136 controls the projection controller 103 to start switching the input to the projection unit 60 to the input to the external memory 2 (S1008). After the input switching process starts, the input switching unit 136 sends an input switching start notification to the output controller 132 (S1009). After the input switching process is complete, the input switching unit 136 sends an input switching completion notification to the output controller 132 (S1010). Then, the processes similar to the ones in S510 and S511 are performed.

Due to the configuration described above, an input switching process starts after the ongoing-transmission of contents is terminated. Accordingly, interruption is prevented between the ongoing-transmission of contents and the transmission of contents from another external device.

In the example embodiment described above, cases in which the content output unit 135 is configured for each external device have been described. However, the content output unit 135 may be only one regardless of the number of external devices to be connected, and the content output unit 135 may generate a video signal from the contents input from the content acquisition unit 133 that is configured for each external device. In this case, the input switching unit 136 performs switching such that the contents stored in the content acquisition unit 133 that corresponds to the connected external device are input to the content output unit 135.

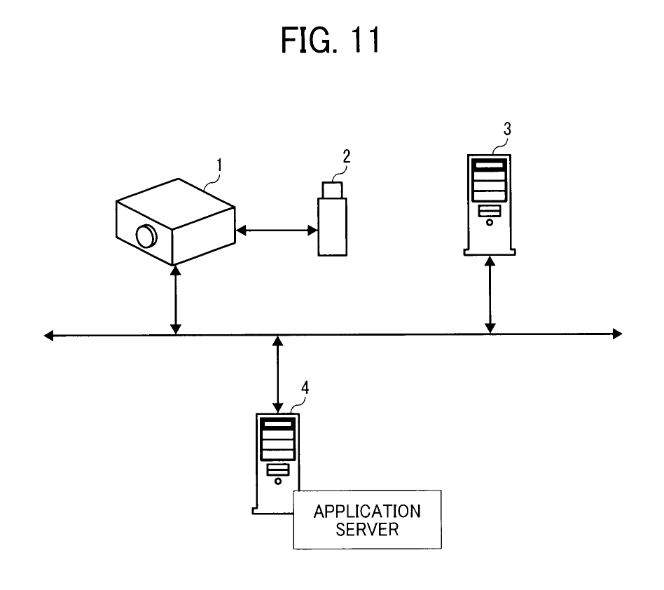

In the example embodiments described above, cases in which the main controller 130 of the projector 1 performs several kinds of processes have been described. Alternatively, an image output system may realize the configuration in which an application server 4 that is connected through the network performs a part of or the entirety of the several kinds of processes, as illustrated in FIG. 11.

In the example embodiments described above, a projector that projects an image on a screen is described as an image output apparatus. However, an image output apparatus according to an example embodiment of the present invention may be, for example, a liquid crystal display (LCD) or an electronic whiteboard that performs input switching in response to a connected external device and projects images based on the contents stored in the connected external device.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc. Alternatively, any one of the above-described and other methods of the present invention may be implemented by ASICs, prepared by interconnecting an appropriate network of conventional component circuits, or by a combination thereof with one or more conventional general-purpose microprocessors and/or signal processors programmed accordingly.

What is claimed is:

1. An image output apparatus comprising:
an image output unit to output an image based on a video signal generated from data;
a storage medium detector to detect a storage medium having available data stored therein;
a data obtaining unit to obtain the data stored in the newly detected storage medium in response to the detection;
an input switching unit to switch, from an input path of the image to be output to an input path associated with the newly detected storage medium; and
a video signal output unit to output a video signal generated from the obtained data after the switching of the input path is complete.

2. The image output apparatus according to claim 1, wherein
the data obtaining unit determines whether or not the video signal is generatable from any of the data stored in the newly detected storage medium, based on projectable data format information that specifies formats used for generating the video signal, and
the input switching unit switches the input path when the data obtaining unit determines that the data from which the video signal is generatable is stored in the storage medium.

3. The image output apparatus according to claim 1, wherein
when the video signal generated from the data stored in a storage medium other than the newly detected storage medium is being output, the video signal output unit terminates the video signal that is being output, and
the input switching unit starts switching the input path after the video signal that is being output is terminated.

4. The image output apparatus according to claim 1, wherein
when the newly detected storage medium includes a plurality of storage media that are detected within a predetermined time range, the apparatus further comprises
a storage medium selection unit to select one storage medium from the plurality of storage media, based on a specified priority level stored in each one of the storage media,
the data obtaining unit obtains the data from the selected storage medium, and
the input switching unit switches an input path through which an image to be output runs to another input path associated with the selected storage medium.

5. The image output apparatus according to claim 1, wherein
the data obtaining unit generates a reference image from the obtained data before the input path is switched, the reference image being used for checking the data.

6. The image output apparatus according to claim 1, wherein
the storage medium detector detects that data becomes available from the storage medium by receiving a connection signal generated when connecting operation to the storage medium is performed.

7. The image output apparatus according to claim 1, wherein
the storage medium detector detects that data becomes available from the storage medium by periodically checking a connection state of the storage medium.

8. An image output system comprising:
an image output unit to output an image based on a video signal generated from data;
a storage medium detector to detect a storage medium having available data stored therein;
a data obtaining unit to obtain the data stored in the newly detected storage medium in response to the detection;
an input switching unit to switch, from an input path of the image to be output to an input path associated with the newly detected storage medium; and
a video signal output unit to output a video signal generated from the obtained data after the switching of the input path is complete.

9. A computer-readable non-transitory recording medium storing an image output control program for causing a computer to execute a method comprising:
outputting an image based on a video signal generated from data;
detecting a storage medium having available data stored therein;
obtaining the data stored in the newly detected storage medium in response to the detection;
switching, from an input path of the image to be output to an input path associated with the newly detected storage medium; and
outputting a video signal generated from the obtained data after the switching of the input path is complete.
